(19) United States
(12) Patent Application Publication
(10) Pub. No.: US 2014/0038646 A1
(43) Pub. Date: Feb. 6, 2014

(54) INSTALLATION AND METHOD FOR LOCATING BY COUPLING OF AUTONOMOUS MEANS FOR MEASURING A DISPLACEMENT TO WIRELESS MEANS OF MEASUREMENT OF LOCATION DATA SUPPORTS

(71) Applicant: Anthony Francheteau, Cholet Cedex (FR)

(72) Inventor: Anthony Francheteau, Cholet Cedex (FR)

(73) Assignee: THALES, Neuilly sur Seine (FR)

(21) Appl. No.: 14/009,946

(22) PCT Filed: Apr. 3, 2012
(86) PCT No.: PCT/EP2012/056039

§ 371 Date: Oct. 23, 2013

(30) Foreign Application Priority Data
Apr. 4, 2011 (FR) 11 01002

(51) Int. Cl. H04W 4/02

(52) U.S. Cl. CPC H04W 4/025
USPC 455/456.6

(57) ABSTRACT

This method for locating a terminal (12) in a zone, said method comprising:
a step (28, 29) of setting the spatial coordinates of the terminal (12), carried out within a geolocation software (16) of the terminal (12);
a step (34) of measuring the displacement of the terminal (12) by autonomous means for measuring a displacement (20, 21) which are integrated into the terminal (12);
a step (36) of estimating the spatial coordinates, carried out by the geolocation software (16) on the basis of the displacement transmitted by the autonomous means for measuring a displacement (20, 21);
a step (30) of displaying the geographical position of the terminal (12) by display means (24) integrated into the terminal (12);
is characterised in that it comprises:
a step (29) of transmission by a location data support (13) installed permanently on site in the zone, of its geographical position to the terminal (12); and
a step (41) of resetting the spatial coordinates of the terminal (12), carried out within the geolocation software (16) on the basis of the geographical position of the location data support (13).

The present invention relates to a method for locating a terminal in a zone, said method comprising:
a step of setting the spatial coordinates of the terminal, carried out within a geolocation software of the terminal;
a step of measuring the displacement of the terminal by autonomous means for measuring a displacement which are integrated into the terminal;
a step of estimating the spatial coordinates, carried out by the geolocation software on the basis of the displacement transmitted by the autonomous means for measuring a displacement;
a step of displaying the geographical position of the terminal by display means integrated into the terminal;

The document EP 1886517 provides a known method and an installation for location by WiFi positioning coupled with an inertial navigation unit. Such a method makes it possible to locate a person or a terminal in a closed environment (for example a building) equipped with telecommunication terminals for a Wifi type wireless local area network.

The method of location uses, from a terminal, the measurements of the transmission power of telecommunication terminals of a WiFi type wireless local area network. A comparison of the received powers that originate from each terminal with power values stored in a database of the terminal is carried out. The power values stored in the database each correspond to a position of the terminal relative to the terminals. The result of the position thus issued is then filtered in order to reduce the effect of noise inherent in the measurements. This filtering is carried out by taking into account inertial navigation data provided by inertial measurement means. Finally, a possible step of correcting the inertial drift due to the method of measurement of the inertial navigation data is applied.

Such a method makes it possible to obtain an almost instantaneous location of a moving object in a closed environment but it however requires an initial step of manual construction of a database within the terminal. In addition, it is necessary to first perform a calibration of the terminal in order to take into account the environment in which the Wifi telecommunications terminals are arranged so as to indicate to the terminal the spatial coordinates of the Wifi terminals. These restrictive features result in increases in the costs of production of the terminal that is designed to implement such a method.

The aim of the invention is to provide a method of location making it possible to overcome the need for the manual construction of a database and for the prior calibration of the environment, and to thereby reduce the associated costs.

To this end, the invention relates to a method of location, of the aforementioned type, characterised in that it comprises:
a step of transmission by a location data support that is permanently installed on site in the zone, of its geographical position to the terminal, and
a step of resetting the spatial coordinates of the terminal that is carried out within the geolocation software on the basis of the geographical position of the location data support.

According to other embodiments, the method of location comprises one or more of the following features, taken into consideration individually or in accordance with any technically possible combinations:
the step of displaying of the geographical position of the terminal on the basis of the spatial coordinates estimated from the displacement transmitted by the autonomous means for measuring a displacement, is carried out only if the software determines that the precision relative to the displacement transmitted by the autonomous means for measuring a displacement is sufficient;
the step of resetting the spatial coordinates is carried out within the geolocation software, when the precision relative to the displacement transmitted by the autonomous means for measuring a displacement is determined to be insufficient by the software;
the step of resetting the spatial coordinates is carried out by the voluntary action of a user equipped with the terminal to be located, on the basis of an information message displayed by the terminal following detection of an insufficient precision relative to the displacement transmitted by the autonomous means for measuring a displacement;
the step of resetting the spatial coordinates is carried out automatically when the terminal to be located enters into a zone of transmission of a location data support;
the geolocation software, during the step of displaying, enables the display of the spatial coordinates transmitted by a GPS sensor as long as the latter are available; and
the geolocation software estimates the spatial coordinates of the terminal on the basis of the displacement transmitted by the autonomous means for measuring a displacement and enables the display of the geographical position of the terminal on the basis of the estimated spatial coordinates when the spatial coordinates provided by the GPS sensor are not available.

The invention also relates to an installation for locating a terminal in a zone, comprising within the terminal:
autonomous means for measuring a displacement;
means for displaying a geographical position;
a data processing unit that implements a geolocation software, said unit being interfaced with the autonomous means for measuring a displacement and the display means;
and characterised in that it includes at least one location data support that is permanently installed on site in the zone and contains the spatial coordinates of the geographical point where it is installed and in that it comprises wireless measuring means for measuring location data supports, and in that the geolocation software is capable of carrying out a resetting of the spatial coordinates of the terminal on the basis of the position information read in at least one location data support.

According to other embodiments, the locating installation includes one or more of the following characteristic features, taken into consideration individually or in accordance with any technically possible combinations:
the installation includes within the terminal a GPS sensor interfaced with the data processing unit;
the autonomous means for measuring a displacement constitute one of the devices that are included in the group consisting of: a two dimensional inertial unit and a three dimensional inertial unit;
the autonomous means for measuring a displacement are coupled to a magnetometer; and
the location data supports constitute one of the devices that are included in the group consisting of: RFID tags using NFC (Near Field Communication) technology, RFID tags using UHF (Ultra High Frequency) technology and 2D bar codes.

These features and advantages of the invention will become apparent upon reading the following description, provided purely by way of example and made with reference to the accompanying drawings, in which:

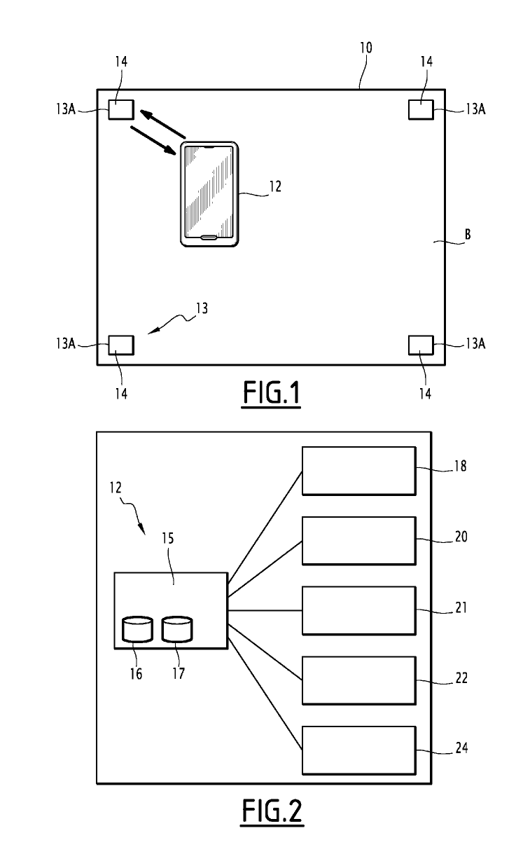

FIG. 1 is a schematic view of a locating installation comprising a mobile terminal to be located and location data supports,

FIG. 2 is a schematic view of the mobile terminal to be located according to one embodiment of the invention, and

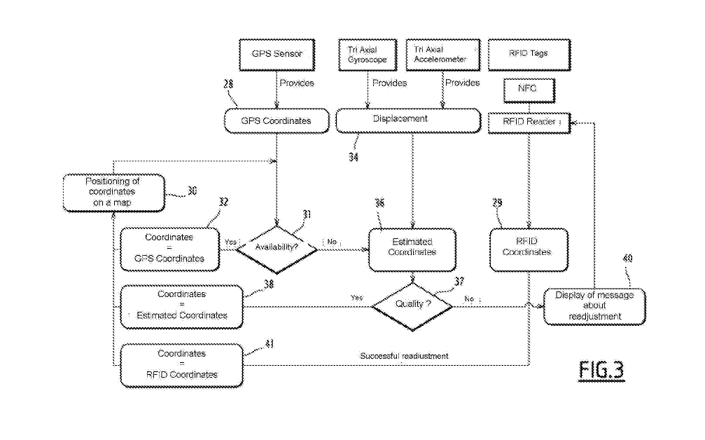

FIG. 3 is a flow sheet of the method according to the invention.

On FIG. 1, a locating installation 10 comprises a mobile terminal to be located 12 and location data supports 13 situated in certain identified fixed points of a geographical zone such as inside a building B.

The mobile terminal 12 is for example a mobile telephone of a cellular network. The mobile terminal 12 is capable of being displaced within the space delimited by the geographical zone.

According to a first embodiment of the invention, each location data support 13 is formed with an RFID tag 13A using NFC (Near Field Communication) technology. Each RFID tag 13A contains the spatial coordinates of the geographical point where it is located. The RFID tags 13A are for example permanently sealed on site in pillars 14 of the structure of the building.

In FIG. 2, the mobile terminal 12, according to a first embodiment, comprises a data processing unit 15 that implements a geolocation software 16 and a module for downloading building plans 17.

The geolocation software 16 is capable of creating a geographical map and of displaying on this map the position of the mobile terminal 12 on the basis of positioning data, as explained in the following sections. In addition, the geolocation software 16 makes possible the implementation of the steps relating to the initial setting up, reception, estimation and resetting of the spatial coordinates of the mobile terminal 12. These steps will be described here below with reference made to FIG. 3.

The downloading module 17 is capable of downloading through the cellular network the plans of buildings equipped with location data supports 13.

In the mobile terminal 12, the unit 15 is connected to:
A GPS sensor 18,
a tri-axial gyroscope 20,
a tri-axial accelerometer 21,
an RFID reader 22, and
a rendering interface 24.

The GPS sensor 18 is capable of receiving signals from positioning satellites and of calculating the spatial coordinates corresponding to the mobile terminal 12 on the basis of these signals.

The triaxial gyroscope 20 is capable of measuring angular velocities along three orthogonal axes of the mobile terminal 12. The angular velocities are each representative of an angle of displacement of the terminal 12 along an axis.

The triaxial accelerometer 21 is capable of measuring linear accelerations along three orthogonal axes of the mobile terminal 12. The accelerations are each representative of a linear displacement of the terminal 12 along an axis.

The triaxial gyroscope 20 is coupled to the triaxial accelerometer 21. The triaxial gyroscope 20 triaxial accelerometer 21 assembly represents a particular embodiment of a three dimensional inertial unit.

The RFID reader 22 is capable of receiving information originating from the location data supports 13, in this case the RFID tags 13A, based on the NFC technology.

The rendering interface 24 is formed by any means for displaying location information in a visual image, such as a display screen for example.

Alternatively, the triaxial gyroscope 20 and triaxial accelerometer 21 assembly is replaced by a two dimensional inertial unit. The embodiment of the device according to this variant is allows location along two dimensions of the mobile terminal 12.

Alternatively, the triaxial gyroscope 20 and triaxial accelerometer 21 assembly is replaced by any autonomous means for measuring a displacement, that is to say without interaction with predetermined elements of the geographical zone.

Alternatively, a magnetometer that is connected to the data processing unit 15 is advantageously coupled to the inertial unit. The magnetometer is capable of measuring the Earth's magnetic field and of confirming the transmitted information relative to displacement of the mobile terminal 12. The steps implemented within the geolocation software 16 will now be described with reference to FIG. 3. The algorithm deployed is implemented in a loop, the position of the mobile terminal 12 being updated periodically, for example every second.

It is assumed for the purposes of the description that the mobile terminal 12 is located following a step of initially setting up as described in the sections here below. The spatial coordinates of the mobile terminal 12 are known within the geolocation software 16 either by means of receiving, during a relevant step 28 the GPS positioning signals, or by receiving during a relevant step 29 the spatial coordinates contained in an RFID tag 13A in the proximity of which the mobile terminal 12 has been voluntarily placed by a user.

Throughout the implementation of the method, the GPS sensor 18 attempts during the step 28 to pick up the GPS signals originating from the satellites. The GPS coordinates of the mobile terminal 12 provided by the GPS sensor 18 are thus either available or not available.

During the step 30, and regardless of the origin of the spatial coordinates, the geolocation software 16 commands the display of the map with an element representative of the position on the map of the spatial coordinates of the terminal 12. The representative element is for example a point.

During the following step 31, a test is performed in order to determine whether the GPS coordinates of the terminal 12 originating from the GPS sensor 18 are available. This may be the case if the GPS sensor 18 is likely to receive the GPS signals originating from satellites. However, if the terminal 12 is somehow masked by the building B, it may be that the signals are not accessible.

If the GPS coordinates are provided by the GPS sensor 18, the coordinates of the point to be displayed are taken to be equal to the GPS coordinates in step 32, and then the step 30 of displaying the position is re-implemented.

The geolocation software 16 thus uses the spatial coordinates transmitted by the GPS sensor 18 for the location of the mobile terminal 12, as long as these spatial coordinates are available.

During the entire process of implementing the method, the triaxial gyroscope 20 and the triaxial accelerometer 21, during the step 34, transmit information relative to the three dimensional displacement of the terminal 12 to the geolocation software 16. This information is obtained from a combination between the measurement of angular velocities of the mobile terminal 12 by the triaxial gyroscope 20 on the one hand, and the measurement of linear accelerations of the mobile terminal 12 by the triaxial accelerometer 21 on the other hand.

If the spatial coordinates transmitted by the GPS sensor 18 are no longer available during step 31, the geolocation software 16, during the step 36 estimates the spatial coordinates of the mobile terminal 12 on the basis of the displacement transmitted by the triaxial gyroscope 20 and the triaxial accelerometer 21.

During the step 36, an uncertainty of positioning is calculated by the geolocation software 16. It is for example given to be equal to the sum of the errors of measurement of the various displacements transmitted by the triaxial gyroscope 20 and the triaxial accelerometer 21 from the last resetting of the mobile terminal 12.

During the following step 37, the quality of the positioning is determined by means of a test. The test consists of comparing the uncertainty of positioning calculated by the geolocation software 16 during the step 36 to a maximum tolerable precision uncertainty. This maximum tolerable precision uncertainty is the result of a combination between a first information component intrinsic to the geographical environment in which the mobile terminal 12 is displaced and a second information component suitable for the intended use envisaged for the method of location. For example, this maximum tolerable precision uncertainty is obtained by a combination between a first precision related information component downloaded by the downloading module 17 at the same time along with the corresponding plan of a building, and a second precision related information component stored in the geolocation software 16 for a given use.

If, during the step 37 the uncertainty of positioning calculated by the geolocation software 16 is less than the maximum tolerable precision uncertainty, the coordinates of the point to be displayed are taken to be equal in the step 38 to the coordinates estimated in step 36. The step 30 of displaying the position on the basis of these estimated coordinates, followed by the step 31 of testing for the availability of signals originating from satellites, are then re-implemented.

If, during the step 37, the uncertainty of positioning calculated by the geolocation software 16 is greater than the maximum tolerable precision uncertainty, a resetting of the spatial coordinates is initiated within the software 16.

To this end, during the step 40, the rendering interface 24 receives a message from the geolocation software 16 with information indicating the need to reset the mobile terminal 12 with an RFID tag 13A, and visually renders this message. After reading such an information message, the user equipped with such a mobile terminal 12 voluntarily places the terminal in the proximity of one of the RFID tags 13A which he knows the presence.

The RFID tag 13A used for the resetting transmits its spatial coordinates during the step 29 to the RFID reader 22 in response to a query performed by the reader 22.

The RFID reader 22 transmits these spatial coordinates to the geolocation software 16, which then uses them as new coordinates for the mobile terminal 12 during a step 41 where the coordinates of the point to be displayed are taken to be equal to the spatial coordinates of the RFID tag 13A. The representative point of the position is displayed on the map during the step 30 and then the test of step 31 is re-implemented.

The geolocation software 16 then reuses the spatial coordinates transmitted by the GPS sensor 18 or the spatial coordinates estimated on the basis of the displacement signal transmitted by the triaxial gyroscope 20 and the triaxial accelerometer 21, according to the conditions previously described depending on the results of the tests carried out in the steps 31 and 37.

Throughout the operation, the downloading module 17 transmits the downloaded building plans to the rendering interface 24.

During the step 30, the rendering interface 24 receives information from the geolocation software 16 related to the location of the mobile terminal 12, and renders this information visually. It also receives the building plans that have possibly been downloaded within the downloading module 17 and visually renders them.

It may thus be understood that such a method of location does not necessitate as a prerequisite the manual construction of any database whatsoever and does not necessitate having to indicate in advance to the mobile terminal 12 the spatial coordinates of the location data supports 13. The possible miniaturization of such a mobile terminal 12 therefore enables the reduction of manufacturing costs.

According to a second embodiment of the invention, each location data support 13 is formed with an RFID tag using UHF (Ultra High Frequency) technology, the RFID reader 22 of the first embodiment, which is capable of receiving information based on the NFC technology, being replaced by a reader which is capable of receiving information based on the UHF technology.

The difference in operation of this second embodiment with respect to the first embodiment lies in the step 29, 41 of resetting the spatial coordinates. Unlike the first embodiment, the rendering interface 24 no longer receives a message from the geolocation software 16 bearing information indicating the need to reset the mobile terminal 12 with an RFID tag.

The step of resetting is carried out under the command of the geolocation software 16 each time that the terminal 12 is sufficiently close to an RFID tag. When the precision relative to the displacement transmitted by the triaxial gyroscope 20 and the triaxial accelerometer 21 is determined to be insufficient by the geolocation software 16, and when the mobile terminal 12 to be located enters into a zone of transmission of an RFID tag, this RFID tag automatically transmits its spatial coordinates to the RFID reader. The functioning of the step of resetting according to this second embodiment is then identical to that of the step 29, 41 of resetting of the first embodiment, and is therefore not described again here.

This automatic resetting of the spatial coordinates, linked to the use of UHF technology and specific to the second embodiment, presents the advantage of overcoming the need for manual action on the part of a user.

According to a third embodiment of the invention, each location data support 13 is formed by a 2D bar code capable of ensuring data storage and the RFID reader 22 of the first embodiment is replaced by a bar code reader.

The functioning of this third embodiment is identical to that of the first embodiment with regard to the device and the method of location, and is therefore not described again here.

1-10. (canceled)

11. A method for locating a terminal in a zone, said method comprising:
a step of setting the spatial coordinates of the terminal, carried out within a geolocation software of the terminal;
a step of measuring the displacement of the terminal by autonomous means for measuring a displacement which are integrated into the terminal;
a step of estimating the spatial coordinates, carried out by the geolocation software on the basis of the displacement transmitted by the autonomous means for measuring a displacement;
a step of displaying the geographical position of the terminal by display means integrated into the terminal;
a step of transmission by a location data support installed permanently on site in the zone, of its geographical position to the terminal; and
a step of resetting the spatial coordinates of the terminal, that is carried out within the geolocation software on the basis of the geographical position of the location data support.

12. A method according to claim 11, wherein:
the step of displaying of the geographical position of the terminal on the basis of the spatial coordinates estimated from the displacement transmitted by the autonomous means for measuring a displacement, is carried out only if the software determines that the precision relative to the displacement transmitted by the autonomous means for measuring a displacement is sufficient;
the step of resetting the spatial coordinates is carried out within the geolocation software, when the precision relative to the displacement transmitted by the autonomous means for measuring a displacement is determined to be insufficient by the software.

13. A method according to claim 12, wherein the step of resetting the spatial coordinates is carried out by the voluntary action of a user equipped with the terminal to be located, on the basis of an information message displayed by the terminal following detection of an insufficient precision relative to the displacement transmitted by the autonomous means for measuring a displacement

14. A method according to claim 12, wherein the step of resetting the spatial coordinates is carried out automatically when the terminal to be located enters into a zone of transmission of a location data support.

15. A method according to claim 11, wherein the geolocation software, during the step of displaying, enables the display of the spatial coordinates transmitted by a GPS sensor as long as the latter are available; and the geolocation software estimates the spatial coordinates of the terminal on the basis of the displacement transmitted by the autonomous means for measuring a displacement and enables the display of the geographical position of the terminal on the basis of the estimated spatial coordinates when the spatial coordinates provided by the GPS sensor are not available.

16. An installation for locating a terminal in a zone, capable of carrying out the method according to claim 11 and comprising within the terminal:
autonomous means for measuring a displacement,
a data processing unit that implements a geolocation software, said unit being interfaced with the autonomous means for measuring a displacement and the display means; wherein the installation includes at least one location data support that is permanently installed on site in the zone and contains the spatial coordinates of the geographical point where it is installed and the installation comprises wireless measuring means for measuring location data supports, and the geolocation software is capable of carrying out a resetting of the spatial coordinates of the terminal on the basis of the position information read in at least one location data support.

17. An installation according to claim 16, wherein the installation includes, within the terminal a GPS sensor interfaced with the data processing unit.

18. An installation according to claim 16, wherein the autonomous means for measuring a displacement constitute one of the devices that are included in the group consisting of: a two dimensional inertial unit and a three dimensional inertial unit.

19. An installation according to claim 16, wherein the autonomous means for measuring a displacement are coupled to a magnetometer.

20. An installation according to claim 16, wherein the location data supports constitute one of the devices that are included in the group consisting of: RFID tags using NFC (Near Field Communication) technology, RFID tags using UHF (Ultra High Frequency) technology and 2D bar codes.
